(19) United States
(12) Patent Application Publication
(10) Pub. No.: US 2017/0210026 A1
(43) Pub. Date: Jul. 27, 2017

(54) Plastic film cutter (DC)

(71) Applicant: Edward Joseph Trnka, Saugerties, NY (US)

(72) Inventor: Edward Joseph Trnka, Saugerties, NY (US)

(21) Appl. No.: 14/998,630

(22) Filed: Jan. 27, 2016

(51) Int. Cl. B26F 3/12

(52) U.S. Cl. CPC B26F 3/12

(57) ABSTRACT

The purpose of the invention is to provide an easier approach to utilizing plastic film wrap in the home by using a method to cut the film cleanly without resorting to tearing the film along a sharp metal or plastic ridge as is found on most commercial products. The device uses a low voltage to melt and cut the film as it is placed on a momentarily heated wire.

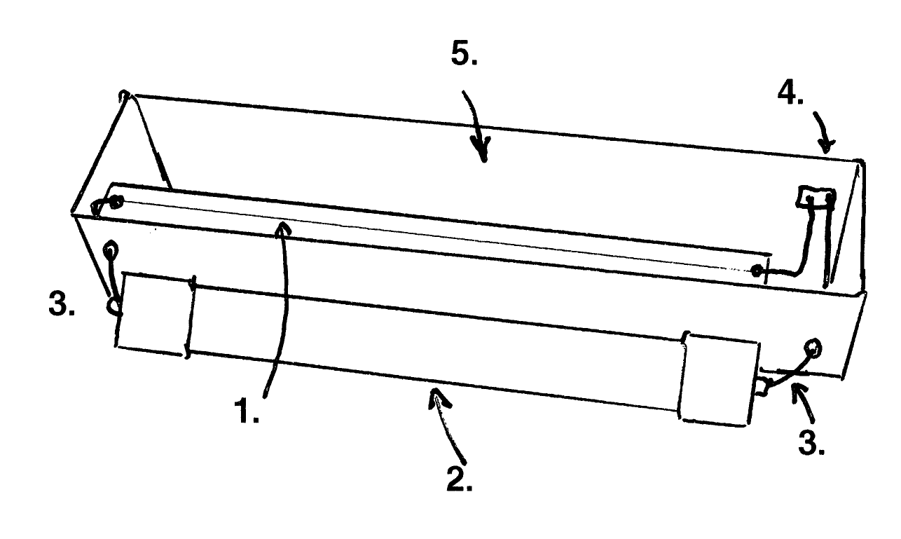

### CROSS-REFERENCE TO RELATED APPLICATIONS

A previous provisional application was submitted under Application No. 62/231/904 on Jul. 20, 2015 and is limited to direct current status.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The device pertains to the use of plastic film in the average home where a sheet of material is removed from the sample box such as Saran wrap or a generic version of the material and cut to utilize a piece for covering a surface for storage or food preparation.

### BRIEF SUMMARY OF THE INVENTION

The device is a more efficient and safer way to utilize the plastic film once it is pulled from the source roll of the box or the roll itself. Once the proper length of film is chosen then the film is cut using a simple electric circuit and a momentary hot wire produced by a push button and battery source.

The previous approach to using plastic wrap and the method to cutting the film is more hazardous when tearing it across a serrated metal strip and ending up with a poor cutting and crumbled film.

### BRIEF DESCRIPTION OF THE DRAWING

The drawing is indicating the various components of the device using a series circuit.
1. Heating element
2. Battery pack
3. Electric wiring
4. Push button switch
5. Plastic wrap compartment

Completion of the series circuit heats the element and cuts the plastic wrap when drawn across momentarily.

### DETAILED DESCRIPTION OF THE INVENTION

The use of plastic film wrap is a common occasion in the residential home. Most often a person will choose to cover leftovers or microwave a product. Normally, the box of film wrap is opened and the film drawn across the serrated edge of the box and ripped off. The invention is built to enclose the wrap and the drawn film is pulled across a stretched brass wire in place of the serrated edge normally in place. When the right amount of film is withdrawn across the wire, a push button is momentarily pressed to complete a simple circuit driven by a 9 volt battery source which in a moment slices the film. After the circuit is opened, the cooled wire holds the end of the film in place.

1. The device or invention has been used in the household for a period of time and it makes it safer and more practical to work with plastic film normally used in the household. The device is portable and requires no other electrical connections. Battery source can be six dry cells, AA or C size.
